(19) United States
(12) Patent Application Publication
(10) Pub. No.: US 2018/0016026 A1
(43) Pub. Date: Jan. 18, 2018

(54) PERCEPTION ENHANCED REFUELING SYSTEM

(71) Applicant: Sikorsky Aircraft Corporation, Stratford, CT (US)

(72) Inventors: Sean S. Carlson, New Milford, CT (US); Cauvin Polycarpe, Middletown, CT (US); Garrett Pitcher, Cheshire, CT (US); George Nicholas Loussides, West Haven, CT (US)

(21) Appl. No.: 15/646,772

(22) Filed: Jul. 11, 2017

Related U.S. Application Data
(60) Provisional application No. 62/362,912, filed on Jul. 15, 2016.

(51) Int. Cl. B64D 39/06; G05D 1/10

(52) U.S. Cl. CPC B64D 39/06; G05D 1/104

(57) ABSTRACT

A system and method for refueling an aircraft during flight is disclosed. A sensor measures a spatial parameter of a probe of the aircraft and of a drogue that provides fuel. A processor predicts a relative position of the probe and drogue from the spatial parameter, calculates a flight trajectory that mates the probe with the drogue based on the predicted relative position of the probe and drogue, and provides a command to the flight control system to fly the aircraft along the flight trajectory to mate the probe with the drogue. When the probe is mated to the drogue, the aircraft is refueled via the connection.

### CROSS REFERENCE TO RELATED APPLICATIONS

The present invention claims priority from U.S. Provisional Application Ser. No. 62/362,912, filed on Jul. 15, 2016, the content of which are incorporated herein by reference in their entirety.

### BACKGROUND OF THE INVENTION

The present invention is directed to a system and method for refueling an aircraft in-flight and, in particular, to automating determination of a flight trajectory that mates refueling components in-flight and controls flight of the aircraft along the determined flight trajectory.

Various aircraft have been built that include components which allow the aircraft to be refueled in-flight, i.e., without having to land the aircraft. One refueling process is known as probe-and-drogue, in which a drogue is extended via a flexible hose from an aft end of a tanker aircraft that includes fuel. A refueling or receiving aircraft flies behind the tanker aircraft at a substantially same speed as the tanker aircraft and maneuvers itself in order to mate a probe on the refueling aircraft with the drogue. Fuel is then delivered to the receiving aircraft from the tanker aircraft via the flexible hose and the mated connection. Current methods of in-flight refueling are performed by the pilot of the refueling aircraft who uses normal flight controls to adjust air speed and position to fly the refueling probe directly into the drogue. There are many variables that the pilot needs to be aware of to successfully mate the probe to the drogue, such as closure rate, distance and relative position of the probe to the drogue. This is a manual process and human error or outside factors can occur, causing fuel spills, damage to aircraft, etc.

### SUMMARY OF THE INVENTION

According to one embodiment of the present invention, a method of refueling an aircraft in-flight includes: obtaining measurements of spatial parameters of a probe of the aircraft and a drogue that provides fuel; running a program on a processor to predict a relative position of the probe and drogue from the spatial parameters, calculate a flight trajectory that mates the probe with the drogue based on the predicted relative position of the probe and drogue, and command the aircraft to fly along the flight trajectory to mate the probe with the drogue; and refueling the aircraft after the probe is mated with the drogue.

According to another embodiment of the present invention, a system for refueling an aircraft during flight includes: a sensor that measures a spatial parameter of a probe of the aircraft and of a drogue; a flight control system that flies the aircraft according to a received command; and a processor configured to: predict a relative position of the probe and drogue from the spatial parameter, calculate a flight trajectory that mates the probe with the drogue based on the predicted relative position of the probe and drogue, and provide a command to the flight control system to fly the aircraft along the flight trajectory to mate the probe with the drogue, wherein mating the probe to the drogue allows refueling of the aircraft.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 schematically illustrates an in-flight refueling operation between a leader aircraft and a follower aircraft;

FIG. 1A shows a close up of a drogue-probe connection that occurs in FIG. 1 at tail end of a flexible hose of the leader aircraft during the refueling operation; and

FIG. 2 shows a schematic diagram of an on-board control system of the follower aircraft that controls a flight trajectory of the follower aircraft 104 to enable refueling of the follower aircraft during flight.

### DETAILED DESCRIPTION

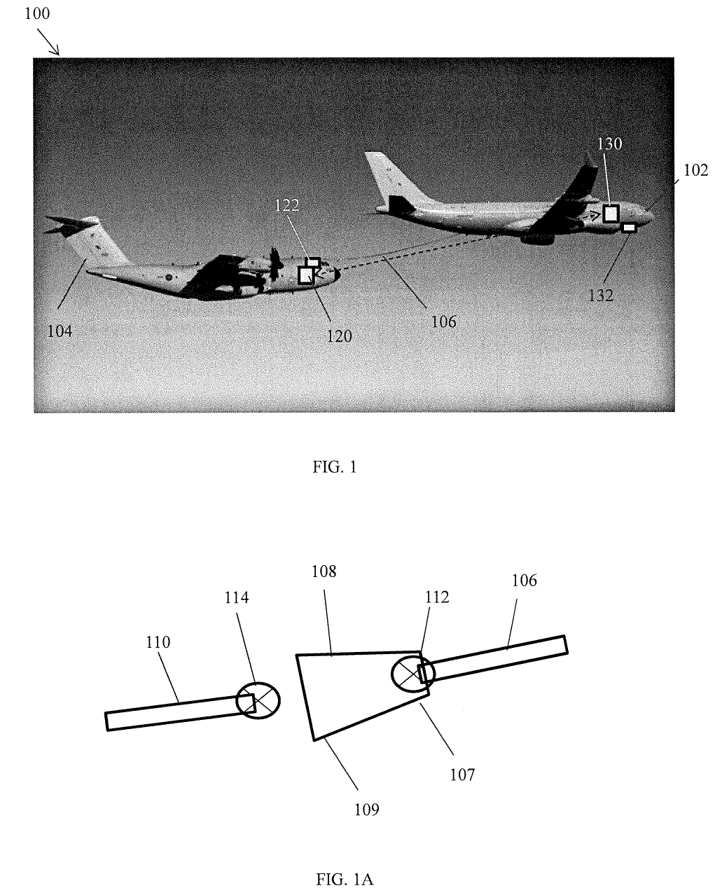

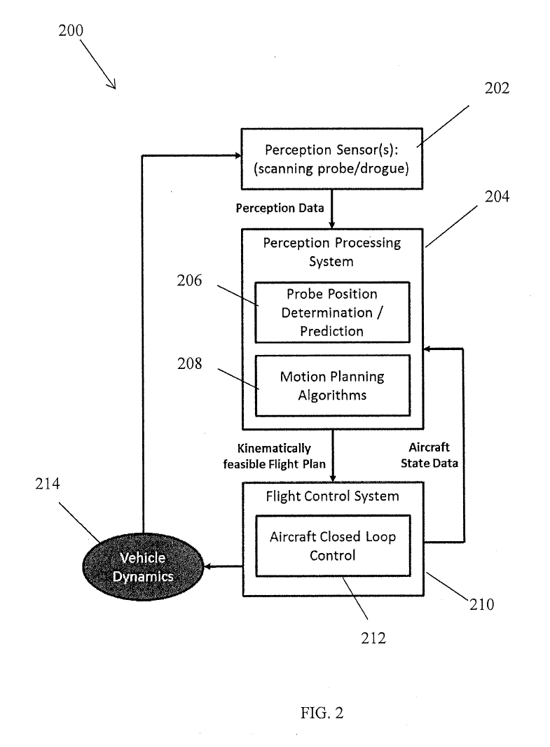

Referring now to the Figures, where the invention will be described with reference to specific embodiments, without limiting same, FIG. 1 schematically illustrates an in-flight refueling operation 100 between a tanker aircraft or leader aircraft 102 and a refueling aircraft or follower aircraft 104. The in-flight refueling operation 100 employs a probe-and-drogue refueling method in which a flexible hose 106 is extended from an aft end of the leader aircraft 102. An on-board control system 120 of the follower aircraft 104 controls the flight of the follower aircraft 104 in order to successfully execute the refueling operation. Operation of the on-board control system 120 is discussed below with respect to FIG. 2.

The leader aircraft 102 further includes an autonomous flight control system 130 that can be used to control a flight plan of the leader aircraft 102. The autonomous flight control system 130 can communicate with the on-board control system 120 of the follower aircraft 104 in order to bring the leader aircraft 102 and follower aircraft 104 into relative position for refueling the follower aircraft 104.

In one embodiment, the on-board control system 120 of the follower aircraft 104 communicates its flight status, including location, velocity, etc., to the autonomous flight control system 130 as well as any constraints on its flight envelope. The autonomous flight control system 130 receives the flight status of the follower aircraft 104 and computes a cooperative flight plan that positions the leader aircraft 102 and the follower aircraft 104 relative to each other to perform a refueling operation. The cooperative flight plan includes a flight plan portion for the leader aircraft 102 and a flight plan portion for the follower aircraft 104. The leader aircraft 102 transmits the follower's portion of the flight plan to the follower aircraft 104. The on-board control system 120 of the follower aircraft 104 flies the follower aircraft 104 according to the follower's portion of the flight plan. In one embodiment, the follower aircraft 104 employs a LIDAR (Light Detection and Ranging) system 122 to track its flight through the follower's portion of the flight plan. The leader aircraft 102 can also employ a LIDAR system 132 to track its flight through the leader's portion of the flight plan. The leader aircraft 102 and follower aircraft 104 can repeat this communication and flight planning process a plurality of times in order to revise flight plans as necessary to set up for the refueling operation.

FIG. 1A shows a close up of a drogue-probe connection that occurs in FIG. 1 at the tail end of the flexible hose 106 during a refueling operation. A drogue 108 is attached to a distal end of the flexible hose 106 and trails behind the leader aircraft 102. The drogue 108 generally resembles a funnel with a narrow end 107 of the funnel attached to the flexible hose 108 and a wide end 109 that faces away from the leader aircraft 102 and toward a follower aircraft 104. A drogue valve 112 can be opened to allow fuel to flow through the flexible hose and closed to stop fuel flow. The flexible hose 106 and drogue 108 are extended from the leader aircraft 102 during refueling and can be reeled into the leader aircraft 102 when refueling is completed.

The follower aircraft 104 includes a probe 110 which is generally a rigid, protruding or pivoted arm placed on a nose or fuselage of the follower aircraft 104. In some embodiments, the probe 110 can be retracted into the follower aircraft 104 when not in use. A probe valve 114 located on the probe 110 is generally closed until the probe 110 mates with the drogue 108, after which the probe valve 114 can be opened to allow fuel to pass from the leader aircraft 102 to the follower aircraft 104. The probe valve 114 may also include a securing feature or securing component that allows the probe 110 and the drogue 108 to form a secure connection that establishes a fluid passage through which fuel can be transferred from the leader aircraft 102 to the follower aircraft 104 without spillage.

FIG. 2 shows a schematic diagram of the on-board control system 200 of the follower aircraft 104 that controls a flight trajectory of the follower aircraft 104 to enable refueling of the follower aircraft 104 during flight. The on-board control system 200 includes perception sensors 202, a processing system 204 and a flight control system 210.

The perception sensors 202 include one or more sensors that scan a volume of space that includes the probe 110 and the drogue 108. The perception sensors 202 can measure spatial parameters of various objects, such as the positions or locations of the objects and the instantaneous velocities of the objects. In one embodiment, the perception sensors 202 measure a position of the probe 110 and a position of the drogue 108 as well as their respective velocities. Additionally, the perception sensors 202 can measure a positon of the leader aircraft 102 with respect to the follower aircraft 104. In general, the perception sensors 202 measure these positions and velocities with respect to a coordinate system based in the follower aircraft 104. In one embodiment, the perception sensors employ LIDAR system 122 to determine the position of the probe 110 and the position of the drogue 108 and their velocities. LIDAR system 122 can be used to construct three-dimensional point clouds which can be used to derive these position and velocity parameters. In alternate embodiments, other position detection systems may be used, such as video systems, radar, three-dimensional cameras, two-dimensional camera imaging, acoustic imaging, etc.

From the measured positions and velocities, the processing system 204 determines or predicts a position of the drogue and probe at a selected future time and determines a kinematically feasible flight trajectory by which the follower aircraft 104 can mate the probe 110 to the drogue 108 at the selected future time. A probe positon determination module 206 of the processing system 204 determines or predicts the future a relative position between the probe 110 and the drogue 108 based on the positions from the perception sensors 202. A motion planning module 208 of the processing system 204 calculates a flight trajectory that allows the probe 110 to mate with the drogue 108 based on the relative and/or predicted positions between the probe 110 and the drogue 108, etc. Calculation of the flight trajectory includes data indicative of a flight state of the follower aircraft 104, such as its current speed, orientation, power levels, etc.

Upon determining the flight trajectory, the motion planning module 208 may determine and output a set of flight instructions to the flight control system 210 in order to command the follower aircraft 104 to fly along the determined flight trajectory. The flight control system 210 performs the commanded actions on the follower aircraft 104 to control the vehicle dynamics 214 of the follower aircraft 104.

As the follower aircraft 104 moves along the commanded flight trajectory, conditions may change which require a change in the commanded flight trajectory. The on-board control system 200 therefore runs a closed control loop program to control the flight of the follower aircraft 104 to mate the probe 110 and the drogue 108 as well as during a refueling process. When running the closed loop program, the on-board control system 200 operates without or independent of input from the pilot.

Running the closed loop program allows the on-board control system 200 to continuously monitor and measure the positions and velocities of the probe 110 and drogue 108, providing constantly updated position and velocity data which are used to calculate new and updated flight trajectories. The processing system 204 is provided with the updated information concerning the position of the probe 110 and the drogue 108 as well as updated flight state parameters of the follower aircraft 104. The processing system 204 uses this information in order to calculate an updated flight trajectory and provides new commands to the flight control system 210 in order to fly the follower aircraft 104 along the updated flight trajectory.

In various embodiments, the pilot can provide an activation signal to the on-board control system 200 in order to refuel the aircraft as described herein without any input from the pilot. The activation signal may be provided by having the pilot push a button, flip a switch, or activate any other device suitable for receiving pilot input. Upon mating, the on-board control system 200 can activate or open probe valve 114 and/or drogue valve 112 in order to open a pathway for fuel. Similarly, the on-board control system 200 can close probe valve 114 and/or drogue valve 112 once the follower aircraft 104 has been refueled. During refueling, the on-board control system 200 can continue to monitor the positions of the follower aircraft 104 and the leader aircraft 102 in order to maintain a secure and safe refueling connection between the probe 110 and the drogue 108. Once the follower aircraft 104 has been refueled, the on-board control system 200 can disengage the probe 110 from the drogue 108 and return control of the follower aircraft 104 to the pilot.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A method of refueling an aircraft in-flight, comprising:
obtaining measurements of spatial parameters of a probe of the aircraft and a drogue that provides fuel;
running a program on a processor to:
predict a relative position of the probe and drogue from the spatial parameters,
calculate a flight trajectory that mates the probe with the drogue based on the predicted relative position of the probe and drogue, and
command the aircraft to fly along the flight trajectory to mate the probe with the drogue; and
refueling the aircraft after the probe is mated with the drogue.

2. The method of claim 1, wherein running the program further comprises running a closed loop program to mate the probe to the drogue independent of input from a pilot.

3. The method of claim 2, wherein the closed loop program obtains updated measurements of the spatial parameters of the probe and the drogue, calculates an updated flight trajectory based on the updated measurements and commands the aircraft to fly along the updated flight trajectory in order to mate the probe with the drogue.

4. The method of claim 1, wherein the program changes a state of a valve upon mating the probe to the drogue in order to commence refueling of the aircraft.

5. The method of claim 1, wherein the drogue is included on a leader aircraft and the aircraft is a follower aircraft of the leader aircraft, the method further comprising determining a cooperative flight plan for the leader aircraft and the follower aircraft and flying the follower aircraft according to a follower portion of the flight plan.

6. The method of claim 5, further comprising communicating a flight envelope of the follower aircraft to the leader aircraft, determining the cooperative flight plan at the leader aircraft and communicating the follower portion of the flight plan from the leader aircraft to the follower aircraft.

7. The method of claim 1, wherein sensing the position of the probe and of the drogue includes performing at least one of: (i) LIDAR; (ii) video ranging; (iii) radar; (iv) three-dimensional camera imaging; (v) two-dimensional camera imaging; and (vi) acoustic imaging.

8. The method of claim 1, wherein the program maintains control of flight of the aircraft while the aircraft is refueling.

9. A system for refueling an aircraft during flight, comprising:
a sensor that measures a spatial parameter of a probe of the aircraft and of a drogue;
a flight control system that flies the aircraft according to a received command; and
a processor configured to:
predict a relative position of the probe and drogue from the spatial parameter,
calculate a flight trajectory that mates the probe with the drogue based on the predicted relative position of the probe and drogue, and
provide a command to the flight control system to fly the aircraft along the flight trajectory to mate the probe with the drogue, wherein mating the probe to the drogue allows refueling of the aircraft.

10. The system of claim 9, wherein the processor is further configured to run a closed loop program to mate the probe to the drogue independent of input from a pilot.

11. The system of claim 10, wherein, in the closed loop program, the processor receives updated measurements of the spatial parameters of the probe and the drogue, calculates an updated flight trajectory based on the updated measurements and commands the aircraft to fly along the updated flight trajectory in order to mate the probe with the drogue.

12. The system of claim 9, wherein the processor is further configured to change a state of a valve upon mating the probe to the drogue in order to commence refueling of the aircraft.

13. The system of claim 9, wherein the drogue is included on a leader aircraft and the aircraft is a follower aircraft of the leader aircraft, and wherein the leader aircraft determines a cooperative flight plan for the leader aircraft and the follower aircraft and the follower aircraft flies according to a follower portion of the cooperative flight plan.

14. The system of claim 13, wherein the follower aircraft communicates a flight envelope of the follower aircraft to the leader aircraft, the leader aircraft determines the cooperative flight plan and communicates the follower portion of the cooperative flight plan to the follower aircraft.

15. The aircraft of claim 9, wherein the sensor includes at least one selected from the group consisting of: (i) LIDAR; (ii) video ranging; (iii) radar; (iv) three-dimensional camera imaging; (v) two-dimensional camera imaging; and (vi) acoustic imaging.
